(19) United States
(12) Patent Application Publication
(10) Pub. No.: US 2026/0250896 A1
(43) Pub. Date: Aug. 27, 2026

(54) FILTER DRAINAGE

(71) Applicant: Inheriting Earth Limited, St Philips (GB)

(72) Inventors: Reuben D'Orton-Gibson, Bristol (GB); Michael Lawrance-Owen, Bristol (GB); Fergal Feeney, Bristol (GB)

(73) Assignee: Inheriting Earth Limited, St Philips, BS (GB)

(21) Appl. No.: 19/163,454

(22) PCT Filed: Mar. 10, 2024
(86) PCT No.: PCT/IB2024/052303

§ 371 Date: Sep. 9, 2025

(30) Foreign Application Priority Data
Mar. 10, 2023 (GB) 2303533.0

(51) Int. Cl. D06F 39/10; B01D 35/02; B01D 35/153; D06F 103/42

(52) U.S. Cl. CPC D06F 39/10; B01D 35/02; B01D 35/153; D06F 2103/42

(57) ABSTRACT

The invention relates to a filter system for liquid effluent handling equipment, such equipment including a reservoir (208) for holding effluent and a pump (205) for emptying the reservoir, wherein the filter system includes: a holding volume (201) for holding a quantity of effluent, the holding volume being fluidly communicable with an outlet of the pump, a filter unit (204) having an inlet in fluid communication with, and downstream from, the holding volume, the filter unit further having an outlet that is connectable to a sewerage system, the filter system characterised in having: a non-return assembly (211) between the holding volume and the filter unit for preventing effluent from returning to the holding volume, an air inlet (210) in fluid communication with the holding volume, the air inlet arranged to allow air into the holding volume, and a control unit (104) for controlling the pump.

### BACKGROUND

### Field of the Invention

The invention relates to the field of the filtration of fluids, including effluent from laundering, cleaning and water treatment systems. In particular the invention relates to effectively draining liquids from the filter of such systems for improved usability.

### Description of Related Art

Effluent produced during cleaning operations must be filtered to remove impurities before being released into the environment. For example, the handling of textiles in manufacturing and washing processes are performed using quantities of fluids to remove entrained debris and dirt. The resulting debris-laden fluid must itself be cleaned to prevent pollution of the environment. For example, the significant problem of the pollution of the world's oceans by plastic is due substantially to the small fibres produced during the washing of clothes made of synthetic fibres in domestic and commercial washing machines. Advanced filters for domestic and commercial laundry devices are now being developed to deal with this problem, such as described in PCT/IB2022/061489.

Existing filters in domestic washing machines are designed to trap large objects such as coins. The filters are called “penny trap” filters, and are intended to protect a drain pump from damage from these large objects. It is not common for a user to access the penny trap filter, so these filters are not designed to be easily accessible and other design considerations take priority; for example, it is preferable for the drain pump to remain full of waste-water between washes so that it is primed for its next use and therefore the penny trap filter would be full of waste-water too between washes. This means that for a user to access the penny trap filter, the user has to manually drain the waste-water from the drain pump and filter arrangement, which is a time-consuming and messy operation. This is not a problem when the filter is only rarely accessed, but with the awareness of the need to filter out much more entrained debris, in particular the microfibres and microplastics created during wash cycles, the need arises to access the filter to empty it more often. It is not realistic for a user to drain the filter frequently, so an automatically draining filter is required, so that its contents are relatively dry when a user empties it.

A similar problem exists in the field of cleaning systems, for example floor cleaners. The operation of a floor cleaner involves spraying clean soapy water onto a floor, sucking up dirty water and filtering the dirty water. Draining the filter so that it is dry when it is emptied is preferable.

A similar problem exists in the field of Waste Water Treatment Plants, where it is required to drain a filter unit prior to accessing and emptying the captured particles from the filter. In the commercial environment it is essential that this is done in an efficient manner as any downtime is costly. Therefore, by draining the filter it is easier and quicker for the operator to remove captured particles and return the system to operation.

Similarly, where a filter is used in textile manufacturing facilities to capture particles during wet processing procedures, there is a requirement for an operator to access and remove these captured particles for the filter system periodically. It is advantageous to have drained the filter and capture area, to facilitate efficient operation in the commercial environment.

### SUMMARY OF THE INVENTION

In an embodiment, a filter system for liquid effluent handling equipment, such equipment including a reservoir for holding effluent and a pump for emptying the reservoir, wherein the filter system includes: a holding volume for holding a quantity of effluent, the holding volume being in fluid communication with, and downstream from, an outlet of the pump, and a filter unit having an inlet in fluid communication with, and downstream from, the holding volume, the filter unit further having an outlet that is connected to a sewerage system, the filter system characterised in having a non-return assembly between the holding volume and the filter preventing effluent from returning to the holding volume, and an air inlet in fluid communication with the holding volume, the air inlet being arranged to allow air into the holding volume, and a control unit for controlling the pump.

In an embodiment, a filter system for liquid effluent handling equipment is provided, such equipment including a reservoir for holding effluent, wherein the filter system includes: a pump for emptying the reservoir, a holding volume for holding a quantity of effluent, the holding volume being fluidly communicable with an outlet of the pump, and a filter unit having an inlet in fluid communication with, and downstream from, the holding volume, the filter unit further having an outlet that is connectable to a sewerage system, the filter system characterised in having a non-return assembly between the holding volume and the filter unit for preventing effluent from returning to the holding volume, and an air inlet in fluid communication with the holding volume, the air inlet arranged to allow air into the holding volume, and a control unit for controlling the pump.

In an embodiment a washing machine, a floor cleaner, a waste-water treatment plant or a textile manufacturing facility having the filter system described above are provided.

In an embodiment, a method of operating a filter system is provided, comprising the steps of operating a drain pump to drain effluent from a reservoir into a holding volume and then into a filter unit and from the filter unit to an outlet, determining when the reservoir has drained to a pre-determined level, then operating the drain pump so that a pre-determined volume of effluent returns to the reservoir, allowing air into the holding volume as the effluent returns to the reservoir from the holding volume, while preventing effluent from returning from the filter unit to the holding volume.

The method may further include repeating the steps of operating the drain pump to drain effluent from the reservoir into the holding volume and then operating the drain pump to allow effluent to flow back into the reservoir and allowing air into the holding volume, while preventing effluent from returning from the filter unit to the holding volume.

The liquid handling equipment could be textile processing or laundering equipment such as a washing machine, or the equipment could be a cleaning device such as a floor cleaner, or the equipment could be a large Waste Water Treatment plant, or textile manufacturing facility. The reservoir may be a sump in a washing machine or a tank for collecting dirty water in a floor cleaner. The holding volume could be a drain tank that is part of the drainage system of a washing machine or floor cleaner or Waste Water Treatment plant. The non-return assembly could be created by locating the holding volume above the filter unit so that a part of the draining fluid is prevented from flowing back into the holding volume and is instead replaced with air drawn into the system via the air valve.

The advantage of the filter system is that it enables a filter unit to be drained and removed without flooding of water. The system also removes the need for an additional drain pump for the filter unit because the existing drain pump of a washing machine is used to create a piston effect that pumps air into the drainage system. This allows the filter unit to be located anywhere in the washing machine and prevents the build-up of microbiology associated with the usual drainage systems of washing machines that remains when between washes.

In some cases, fluid processing systems, such as washing machines and specifically commercial washing machines, may not have a pre-existing drainage pump as they are designed to drain by gravity. When a filter is included in the design of these systems, a pump may be required to supply fluid through the filter and to the sewerage outlet, due to the additional restriction created by the filter system. The benefit of the drainage system described here is that this same pump can be used for two operations, both supply of fluid through the filter and also the drainage of the filter of that fluid. The drainage system can work with a filter system that is located both internally to an appliance, such as a washing machine, and externally. In the scenario with a filter system external to the appliance and the drainage pump internal to the appliance, the two systems can operate by being in both fluid communication and control communication with the drainage pump, despite components being housed separately. This can be advantageous as it allows for modularity and retrofitting of filter systems onto existing appliances or where there are design constraints to house the filter system internally to the appliance.

### BRIEF DESCRIPTION OF THE DRAWINGS

FIG. 1 is a cross-sectional diagram showing the components of a conventional washing machine.

FIG. 2 is a schematic diagram showing the components of an embodiment.

FIG. 3 is a schematic diagram showing the relative heights of the components of an embodiment.

FIG. 4 is a schematic diagram showing the relative quantities of fluid in a holding volume pump and a reservoir when a drainage pump is on and off.

FIGS. 5A to 5I are schematic diagrams showing step-by-step the operation of a filter system in accordance with an embodiment.

FIG. 6A is a schematic diagram showing an embodiment with a filter unit located higher than a drain tank.

FIG. 6B is a schematic diagram showing an embodiment with an outlet located lower than a filter unit.

FIGS. 7A to 7E are schematic diagrams showing an embodiment of a washing machine with the filter system arranged to recirculate waste-water to the drum of the washing machine.

FIG. 8 is a schematic diagram showing an embodiment of a washing machine with the filter system arranged to recirculate waste-water to the drum with a diverter valve between the filter system and pump to divert waste water between the filter system for recirculation and a drain.

FIG. 9 is a schematic diagram showing an embodiment of a washing machine with the filter system arranged to recirculate waste-water to the drum with a diverter valve between the filter system and drain to divert waste-water between the drum and a drain.

FIG. 10 is a schematic diagram showing an embodiment of a washing machine with the filter system arranged to drain the filter in the middle of a drainage cycle.

FIGS. 11A and 11B are schematic diagrams showing an embodiment of a washing machine with an adapted floating stopper in the sump.

FIGS. 12A and 12B are schematic diagrams showing an embodiment of a washing machine with floating stopper bypass conduit.

FIG. 13A is a drawing of a floor cleaner.

FIG. 13B is a cross section of the floor cleaner of FIG. 13A.

### DETAILED DESCRIPTION OF THE PREFERRED EMBODIMENT

An embodiment that relates to domestic washing machines is described below. While the description that follows focuses on washing machines for clothes, it is to be understood that the teachings herein are not limited to use in washing machines as they are equally suited to other processing appliances, such as but not limited to driers, such as wash-dryer combination machines, tumble driers, dyeing machines, cutting machines, recycling machines, dry cleaning machines and so on. The washing machines or other processing appliances could be domestic or commercial. The teachings herein could also be used in other industries in which microparticles may be generated as a result of processing of items. References to washing machines herein are therefore to be understood as comprising any similar appliance of the types contemplated herein. Furthermore, the system could be applied in the broader context of filtration of effluent from floor cleaners, or in large-scale Waste Water Treatment Plants, or textile manufacturing facilities.

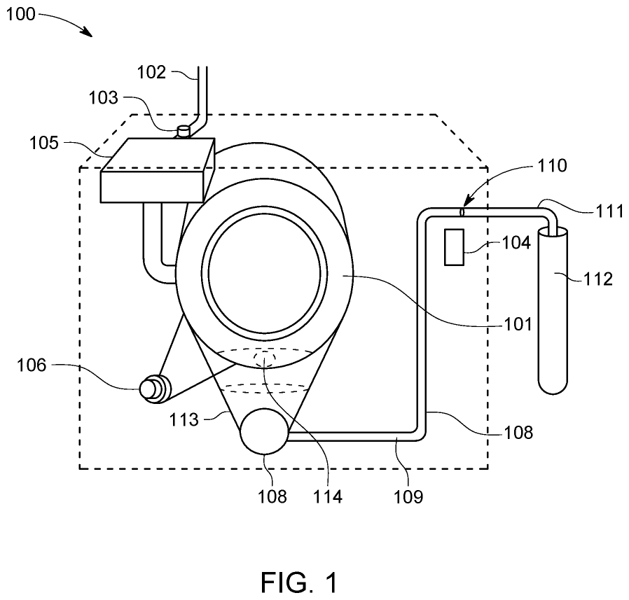

A typical front-loading domestic washing machine is shown in FIG. 1 in schematic form. The machine 100 includes a rotatable sealed drum unit 101 for receiving garments to be washed. The drum unit 101 has a perforated cylindrical rotatable drum mounted inside a static waterproof shroud. Clean water is fed into the drum 101 via a cold water or hot water inlet 102 connected to mains and under mains pressure of typically 1-5 bar. The water entering the drum 101 is managed by an electronic valve, under the control of a CPU 104. The inlet 102 is connected to a drawer 105 where liquid or powdered detergent can be added by a user. The drawer has an outlet that leads to the drum unit 101. The drum unit may include a heater controlled by the CPU to heat the water to the desired wash temperature, typically up to 90 degrees Celsius. The drum is rotatable by an electric motor 106 under the control of the CPU 104 at speeds of typically from 5 to 1600 rpm. The drum unit can be emptied via a drain pump 108 controlled by the CPU. The drain pump is rated with a given power to produce a known pressure at its output. The drain pump feeds into drain conduit 109 which is a section of tubing connected to an outlet point 110 on the outside of the washing machine. The outlet point is connected by a length of tubing 111 to the household or industrial drain 112 and eventually the wastewater network. In a household setting, the drain could be an upstanding open pipe, or a sink or a wall-mounted spigot, which allows wastewater to flow away under gravity into a sewer. The outlet point 110 of the drain conduit 109 of the washing machine is above the drain pump 108.

In another embodiment the filter system could have a means of diverting the filtered water between sewerage and recirculating back into the reservoir. This could be achieved using a diverter valve. It is advantageous as by recirculating the filtered water, the overall water consumption of the appliance can be reduced. A typical top-loading machine will have the axis of the drum vertical but will otherwise share many of the features of the front-loading machine.

In use, dirty laundry is placed in the drum, and a wash cycle initiated by a user. The CPU allows cold water to flow via the drawer to mix with detergent and then on into the drum, where the water is heated. The combined water, detergent and laundry is agitated by rotating the drum. During this process, dirt and grease is released into the water and fibres from the clothing too. If the clothing is synthetic, microfibers are typically released as the clothes rub against each other. The resulting effluent at the end of the wash cycle is a mixture of debris, dirt, grease and microfibers and potentially large objects such as coins or nails left in the clothing. This effluent is then drained and pumped out of the drum at a typical rate of 3-8 gallons per minute. Second or third rinse cycles with clean water may be performed, resulting in effluent with less concentrated contaminants. The drain rate of the washing machine is impacted by the level of water in the drum, the height of the outlet point and if a filter is connected to the outlet.

A drain pump could be a centrifugal type. Centrifugal pumps can cavitate, i.e. when there is no fluid at the input, bubbles form around the rotor and collapse. Any other type of pump could be used, for example peristaltic or diaphragm pumps. Most drain pumps need to be primed to work. Therefore, it is important for a quantity of liquid to remain in the pump so that it is never operated in a dry condition, which can damage the seals and bearings in the pump.

The waterproof shroud gathers waste-water into a sump 113 below the drum. The term “reservoir” in the claims herein is used to refer to this sump or the combination of the sump and drum. In some washing machines, the sump has a floating stopper, which is a hollow ball 114, sometimes referred to as an “eco ball”. The stopper can float on top of the water in the sump and thereby close off the drum housing. This is provided to conserve detergent; when a wash is initiated, the first water to arrive in the drum contains the detergent rinsed out of the drawer; without the ball, this fluid would go straight to the sump and not be available for the wash. Therefore, it is preferable that the sump is full at the end of the wash so that the ball is actively closing off the bottom of the drum housing.

The requirement for a full sump and a wet drain pump means that the drainage section of a typical washing machine is full of waste-water. This means that any equipment in the drainage line will also be wet. This has the disadvantage that, if access to this equipment is required by a user, then they must drain the line, which is time consuming and messy and can lead to flooding. Furthermore, if the washing machine is unused for long periods of time, then microbiological build-up can occur, leading to odours and further mess.

Equipment that is desirable to include in the drainage conduit 109 is a filter, in particular a microplastics filter, such as that described in PCT/EP2022/061489. This unit sits in the drain line and removes fine debris from the flow of waste-water. The unit needs to be periodically emptied and therefore it is desirable that the drain line has no waste-water in it.

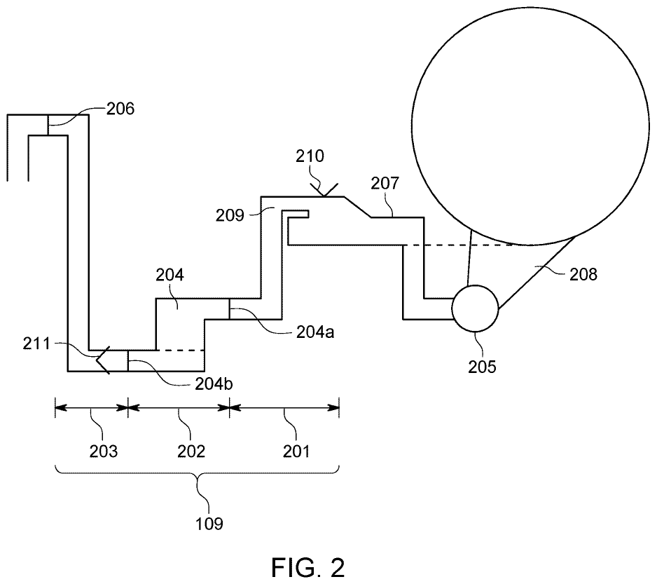

An embodiment of the present invention provides an arrangement for draining a portion of the drainage conduit 109, using the existing drain pump of a washing machine, as shown in FIG. 2. The drainage conduit 109 includes three regions: a waste-water holding region 201 (referred to as a “holding volume” in the claims herein), an equipment region 202 and an outlet region 203. In this embodiment, the equipment in the equipment region is a microplastics filter 204 having an inlet 204a and an outlet 204b. The waste-water holding region 201 is a section of conduit that connects the drain pump 205 to the inlet 204a of the filter 204 in the equipment region 202. The outlet region 203 comprises a length of conduit that connects the outlet 204b of the filter 204 to the outlet point 206 of the washing machine. The outlet region includes a one-way valve 211 at the lowest point, to prevent the flow of waste-water back from the outlet region to the equipment region. This one-way valve is optional and an embodiment without this valve is described in more detail later.

The waste-water holding region 201 includes a drain tank 207 of volume Vt. The volume of the drain tank Vt is approximately equal to the volume of the sump 208 Vs. The drain tank 207 has a drain tank outlet pipe 209 that connects to the equipment region 202. The drain tank outlet pipe 209 is located at the top of the drain tank and rises up from the drain tank and then down towards the equipment region 202 to create a high point in the drain tank outlet. An air inlet 210 is located at the high point in the drain tank outlet. The air inlet 210 includes a one-way valve to allow air into the drain tank 207 but not out.

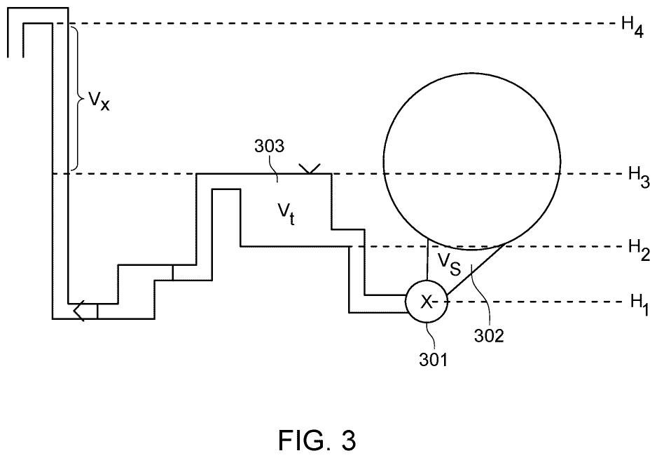

The relative heights of the various elements of the drainage conduit are significant for operation of the drainage system. These relative heights are shown in FIG. 3. The centre of the drain pump 301 defines the zero height H1. The top of the sump is at height H2, which is the same height as the bottom of the drain tank 303. The air inlet is at H3, which is greater than H2. The portion of the outlet region that is above H3, contains a volume Vx. The lower end of Vx is defined as H3 and the upper end H4, is the highest point of the upstanding household drain pipe 112 in FIG. 1.

In a conventional system with a centrifugal drain pump, the drain pump operates until the sump is empty. Then the pump cavitates and cannot push any more waste-water out of the drain conduit. At this point, the drain conduit is full of waste-water, up to the maximum height. When the pump is turned off, the waste-water in the drain conduit falls back through the pump and into the sump where it reaches an equilibrium, such that the sump and drain conduit is partially filled with waste-water at rest.

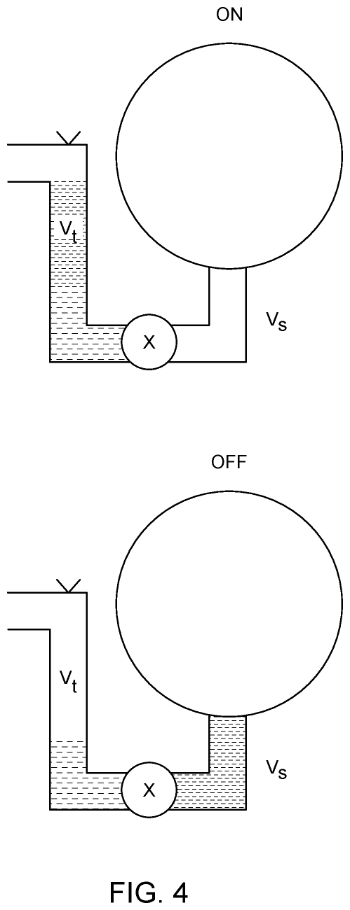

In the present embodiment, an arrangement downstream of the drain pump is provided that utilises some of the waste-water to act as a piston in a pump operation that can continue to operate with a limited volume of waste-water remaining in the drainage system. This is done by ensuring that waste-water that has left the drain tank does not return to it and instead is replaced by air. The principle of operation is shown in FIG. 4, where the volume of waste-water Vt held in the holding tank when the drain pump cavitates is allowed to drain back under gravity into the sump, of volume Vs while the vacant volume Vt is allowed to fill with air. When the drain pump is activated again, the volume Vt of air is then pumped into the drainage system. When the cycle is repeated, another volume Vt of air is pumped into the drainage system. The cycle is repeated until all of the waste-water downstream from the drainage tank is replaced by the air that is pumped into the drainage system.

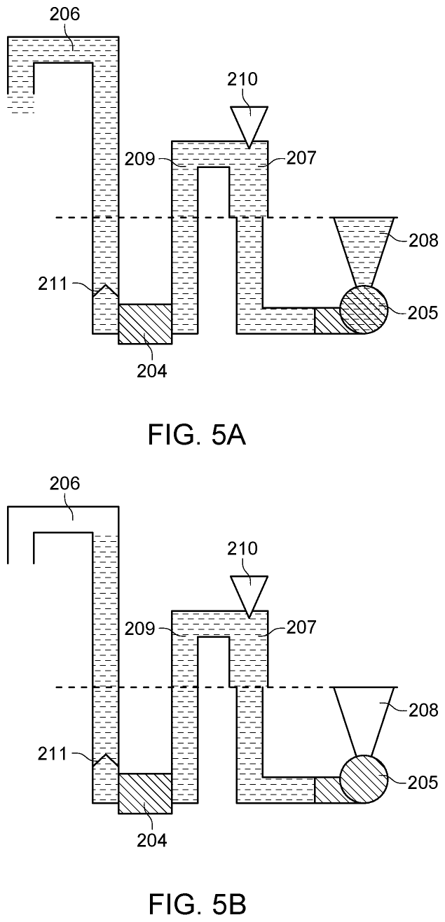

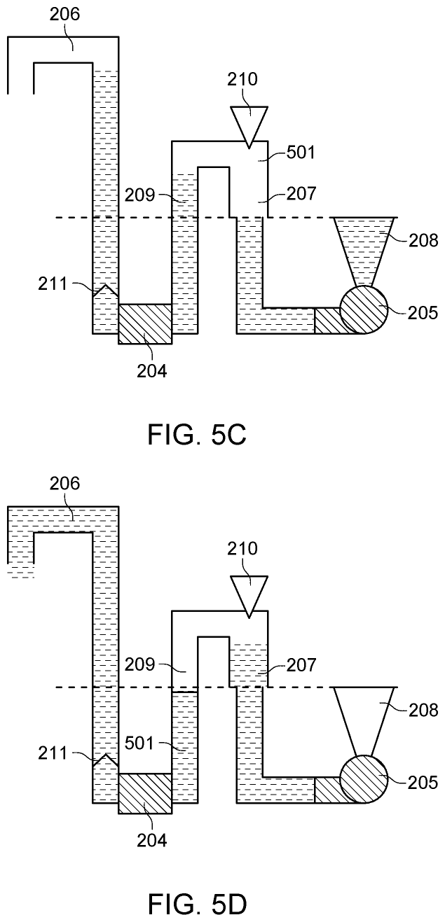

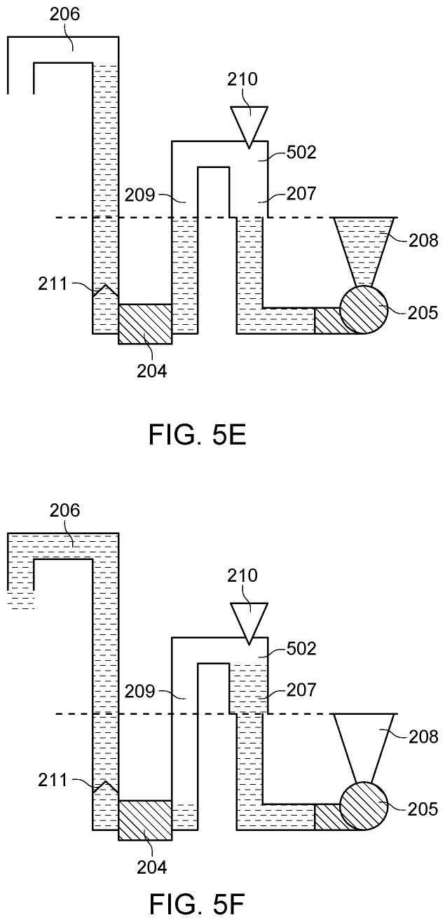

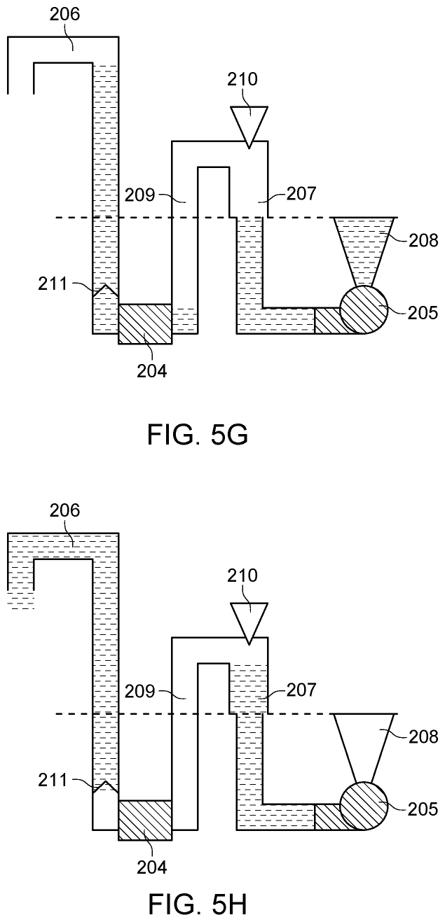

In the present embodiment, when a wash is completed and the drain pump 205 is first activated, the sump 208 is emptied into the drainage conduit and the entire drainage conduit is full of flowing waste-water under pressure, as shown in FIG. 5A.

When the sump 302 becomes empty, the drain pump 205 cavitates and the pressure in the drainage conduit drops to zero as fluid flow towards the outlet 206 stops. The drainage conduit is full along its length with waste-water from the drain pump outlet to the highest point in the outlet region 203, as shown in FIG. 5B.

When this state is detected, either by detecting the lack of waste-water in the sump 208, or the change in the performance of the drainage pump 301 as it cavitates, or by timing, or the drop in pressure in the drainage conduit, the drain pump 205 is turned off, as shown in FIG. 5C. The system is now not in equilibrium because there is a volume of water in the drainage tank 207 at height H2 above the empty sump 208 at height H1. At this stage, the body of waste-water in the drainage conduit would move backwards to fill the sump 208, but the one-way valve 211 prevents this. The drainage conduit upstream of the one-way valve 211 experiences a negative pressure, which causes the air valve 210 to open to allow the fluid in the drain tank 207 to drop back through the drain pump 205 and back into the sump 208. Therefore, by turning the drain pump 205 off, an air pocket 501 is introduced into the drain tank 207. The sump is now full and the drainage pump is primed.

The drain pump 205 is then turned back on, as shown in FIG. 5D. The sump empties and the drain tank 207 fills again, pushing the air pocket 501 through into the equipment region 202. This in turn pushes waste-water out of the outlet 206. The drain tank 207 fills until the sump 208 is empty and the drain pump 205 cavitates again.

When the empty sump 208 is detected, as described above, the drain pump 205 is turned off again, as shown in FIG. 5E. The fluid in the outlet region and the equipment region remains static, while the waste-water in the drain tank 207 flows back through the drain pump 205 into the sump 208, drawing a volume of air in again through the air inlet valve 210 to create a larger air pocket 502 in the system.

When the sump is re-filled, the drain pump 205 is turned back on again, as shown in FIG. 5F, and the larger air pocket 502 is pushed into the drain tank outlet pipe 209 and a further volume of waste-water is purged from the outlet 206.

The movement of waste-water from the drain tank to the sump as the pump is switched off, and then back from the sump to the drain tank, defines a single ‘pump stroke’. The volume of water that is purged from the system during this single pump stroke is defined as the stroke volume, Vstroke and is equal to the volume of waste-water held in the sump, Vs.

The process of switching on the drain pump when the sump is full and off when it is empty is repeated, as shown in FIGS. 5G and 5H to introduce a larger and larger air pocket into the equipment region and outlet region, until almost all of the waste-water is drained from the system, as shown in FIG. 5G

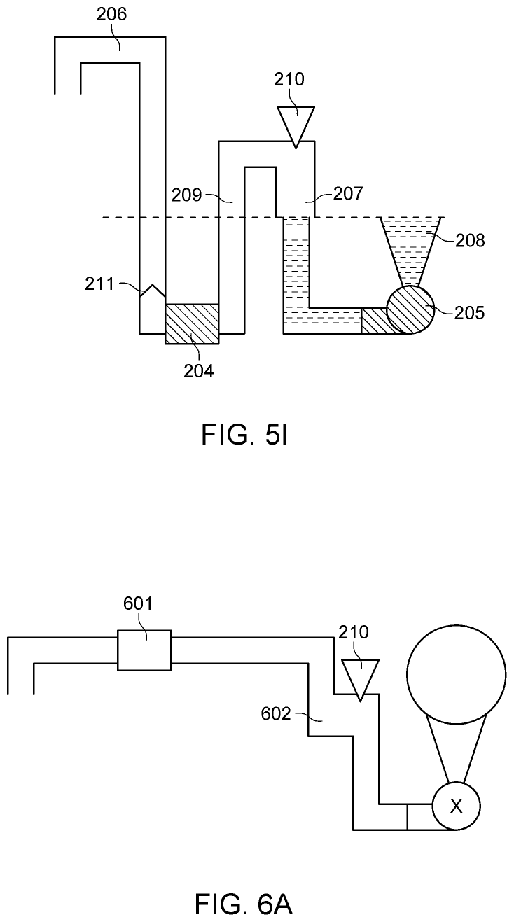

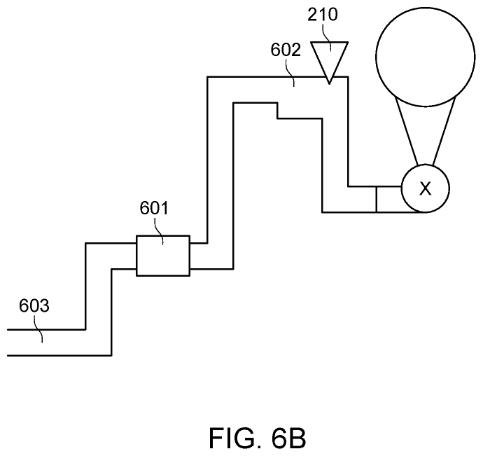

Alternatively, the filter unit 601 can be located above the drainage tank 602, as shown in FIG. 6A.

Alternatively, the outlet 603 can be located below the filter 601, as shown in FIG. 6B.

The one-way valve 211 at the filter unit outlet 206 can be omitted if the sump volume Vs is large enough to accommodate all of the waste-water that flows back out from the outlet region 203. This would be the case if the highest point of the outlet is lower than the top of the drain tank 207. Alternatively, a holding tank could be used at the outlet of the filter to accommodate the backflow from the outlet region.

The CPU 104 of the washing machine is arranged to control the drain pump. A separate control apparatus for the drain pump could be provided. The switching of the drain pump on and off provides the piston effect of the waste-water moving between the sump and the drain tank. The timing of the switching can be controlled in a number of ways:
1. Detecting when the drain pump is cavitating, e.g. using a pressure sensor at the outlet of the drain pump to detect when the pressure of waste-water drops, or detecting when the power consumption of the drain pump decreases.
2. Detecting when the waste-water in the sump has reached a pre-defined level using a fluid level sensor.
3. Calibrating the drainage rate of the washing machine and arranging for the pump to switch off after a pre-defined time. Calibrating the flow of waste-fluid back into the sump from the drainage tank and arranging for the pump to switch on again after a pre-defined time.

The timing parameters or fluid level detectors could be arranged to provide shorter stroke lengths; this would allow the use of a smaller drain tank and cavitation of the drain pump to be avoided. In this case, the volume of the stroke Vstroke is the volume of fluid displaced by one “on” pulse of the drain pump. The benefit of the invention is that it allows drainage of a system downstream from a drain pump, particularly when the system is lower than the drain pump and the outlet of the system.

The air valve 210 could be a one-way valve that operates when the pressure in the drain tank is less than atmospheric pressure, or it could be an electronic valve operated by the CPU 104.

In a further embodiment, the raised drain tank could be replaced with a non-return valve and a drain pump that could be operated in reverse. The pump would be operated to drain the sump and then operated in reverse to refill the sump with waste-water upstream of the non-return valve; the non-return valve would prevent waste-water downstream from returning and instead air would be drawn into the space. Forward operation of the pump would then pump this air into the drainage system and repeated cycling would pump air into the drainage system until all of the waste-water downstream from the no-return valve was displaced.

In a further embodiment, the air-pump system is applied in a washing machine that is arranged to recirculate wash water that is drained from the drum, back again into the drum. Recirculating washing machines use less water than conventional washing machines, by recirculating the wash water that contains the detergent. It also allows more. It also allows for more efficient use of the detergent, preventing a phenomenon where concentrated detergent sits stagnant in the bottom of the drum and sump.

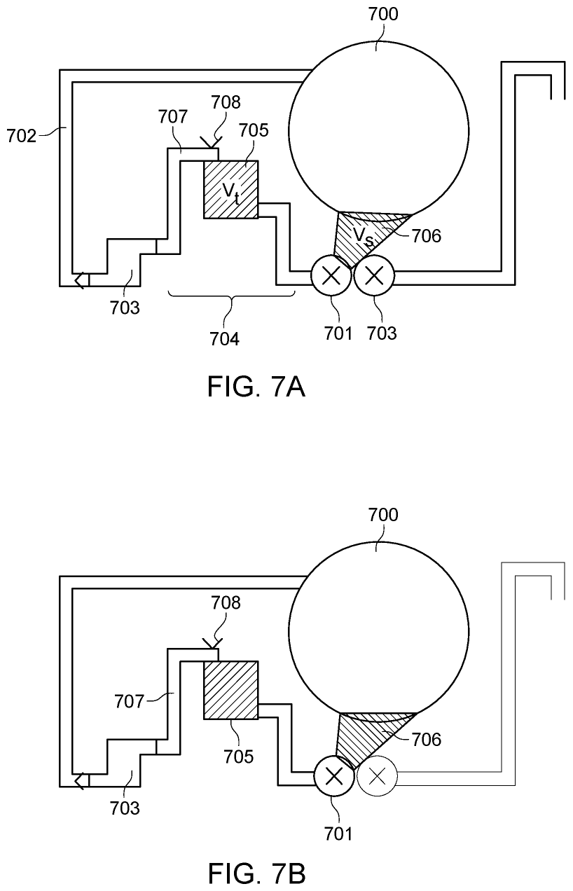

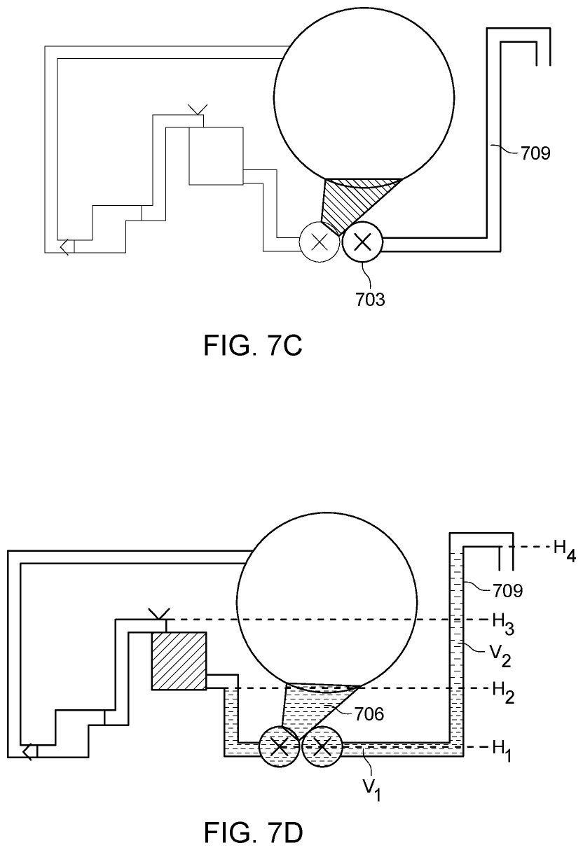

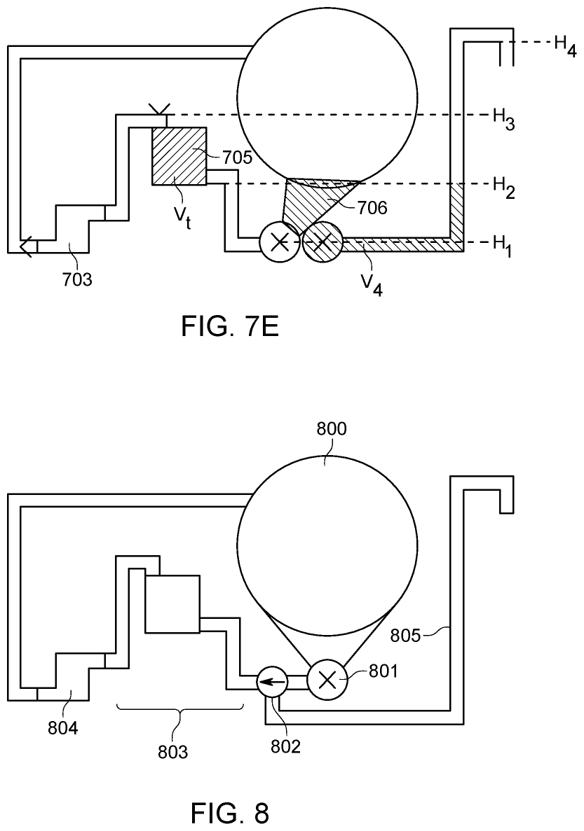

An arrangement of a recirculating system is shown in FIG. 7A. These systems are particularly suited to the air-pump concept because the filter of the recirculation system needs to be cleared much more regularly than a penny trap filter and therefore it needs to be relatively dry to avoid making a mess when it is frequently opened.

During the first wash cycle, the recirculation pump 701 is used to pump the wash water back into the drum 700 and on to the clothes, via recirculation line 702. A filter unit 703 is provided to clean the drained water so that it is suitable for re-use in the drum 700. The filter unit 703 may be a microplastic filter of the type described above and is arranged to remove significant amounts of debris. The filter will therefore need to be emptied every 1 to 20 washes, for example. An air-pump arrangement 704 of the type described above is provided upstream of the filter 703 to drain it so that it can be emptied. The air-pump arrangement 704 includes a waste-water holding region with a drain tank 705 of volume Vt, connected to the recirculation pump by a conduit. The volume of the drain tank Vt is approximately greater than or equal to the volume of the sump 706 Vs, as shown by the cross-hatching in FIG. 7A. The drain tank 705 has a drain tank outlet pipe 707 that connects to the filter 703. The drain tank outlet pipe 707 is located at the top of the drain tank 705 and rises up from the drain tank 705 and then down towards the filter 703 to create a high point in the drain tank outlet pipe 707. An air inlet 708 is located at the high point in the drain tank outlet pipe 707. The air inlet 708 includes a one-way valve to allow air into the drain tank 705 but not out.

In operation, the washing machine fills with clean water and runs a wash. At a predetermined point in the cycle, the recirculation pump 701 is activated, as shown in FIG. 7B, which recirculates the waste-water from the drum 700, through the filter 703 and back to the drum 700 ready for another wash cycle. If the filter 703 becomes clogged or otherwise needs servicing or emptying, then the air-pumping procedure described above with reference to FIGS. 5A to 5F is implemented. This is where the recirculation pump 701 is stopped and the waste-water in the drain tank 705 is allowed to flow back into the sump 706, as air flows into the line via air inlet 708. The recirculation pump 701 is then operated again to refill the drain tank 705, which pushes a volume of air down the drain tank outlet pipe 707. The recirculation pump 701 is operated again to refill the drain tank 705 until it is full, and then the recirculation pump 701 is stopped and the waste-water in the drain tank 705 is allowed to flow back into the sump 706, as air flows into the line via air inlet 708. When the recirculation pump 701 is operated again to refill the drain tank 705, more air is pushed down the drain tank outlet pipe 707. This cycle is repeated until there is only air in the drain tank outlet pipe 707, the filter 703 and recirculation line 702. The filter 703 can then be opened to be inspected or emptied.

When the wash cycle is finished, the drain pump 703 is operated to evacuate the effluent from the drum 700 via drain line 709, as shown in FIG. 7C.

The sump 706 should be left full at the end of a wash cycle, so that the stopper can float to block the drain point of the drum and prevent loss of detergent from the drum during the initial fill. In order to maintain a full sump at the end of the wash cycle, the volume V2 of the drain line 709 between H2, the top of the sump 706, and H4, the highest point of the drain line 709, should be greater than or equal to the volume V1, the volume of all of the conduits below H2, the top of the sump. If the bottom of the drain tank is at the same height as the top of the sump, then no water will overflow the drain tank on the first stroke of the air-pump.

The height H3 of the air inlet valve should be greater than H2 to ensure that the air inlet valve breaks the syphon to allow air to enter the drain tank at the end of the wash.

After operation of the air-pump to leave the filter 703 dry, the sump should be left full so that the stopper operates effectively. For the sump to be full after operation of the air-pump, the volume Vt of the drain tank 705 should be greater than or equal to the volume Vd in the drainage line below the top of the sump, as shown in FIG. 7E.

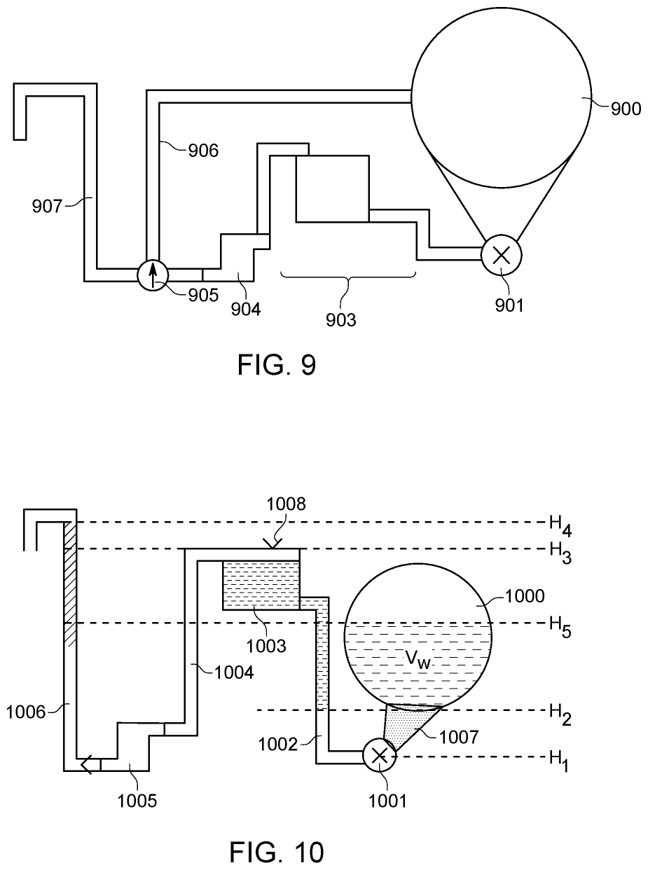

In an alternative embodiment, as shown in FIG. 8, a single pump 801 is provided and a diverter valve 802 for directing the drained wash water either through the air-pump system 803 and the filter 804 assembly, or to the drainage line at the end of the wash cycle. In a further alternative embodiment as shown in FIG. 9, a diverter valve 905 is located downstream of the filter 904 and air-pump assembly 903, and is able to selectively divert fluid flow back through the recirculation line 906 or the drainage line 907.

In another embodiment there may be only a single pump that has two outlets and can operate in a bi-directional manner. This would enable the wash water to either be directed back into the washer drum or to the drain outlet without the requirement of having two pumps for this purpose.

It is possible that the filter unit may need to be accessed by a user before the end of a wash cycle, for example if the filter becomes blocked and needs to be serviced or emptied before the washing machine drum is fully drained. In a further embodiment, the air-pump arrangement described above is adapted to drain a filter downstream of the drain pump in the middle of a wash cycle, as shown in FIG. 10. In this embodiment, the washing machine drum 1000 is shown full of water at height H5. The drum 1000 has a sump beneath it. A drain pump 1001 is provided to drain the drum and sump. A filter 1005 is provided and an air-pump arrangement of the type described above is provided upstream of the filter 1005 to drain it so that it can be emptied. The air-pump arrangement includes a waste-water holding region with a drain tank 1003 of volume Vt. The drain tank 1003 has a drain tank outlet pipe 1004 that connects to the filter 1005. The drain tank outlet pipe 1004 is located at the top of the drain tank 1003 and rises up from the drain tank 1003 and then down towards the filter 1005 to create a high point in the drain tank outlet pipe 1004. An air inlet 1008 is located at the high point in the drain tank outlet pipe 1004. The air inlet 1008 includes a one-way valve to allow air into the drain tank 1003 but not out. The drain tank 1003 is connected to the drain pump 1001 by a conduit 1002. The combined volume of the drain tank Vt and conduit 1002 is approximately greater than or equal to the volume of the sump Vs, as shown by the cross-hatching in FIG. 10. This is to allow the backflow to fill the sump. If the backflow volume is greater than the volume in the sump then there would be a larger volume of water holding the eco-ball in place. The height H3 of the air inlet 1008 is greater than the maximum height H5 of the water in the drum 1000 to ensure that the air inlet 1008 can break the syphon and allow air to enter the drain tank 1003 when the drain pump 1001 turns off.

It may occur that, during drainage of the drum 1000, the filter 1005 becomes blocked. A sensor may be provided to detect this condition, for example a pressure sensor to detect an increase in pressure in the conduit downstream from the drainage pump and upstream from the filter 1005. The drain pump 1001 is then stopped. Gravity acting on the weight of the water in the drain tank operates the air inlet 1008, which then allows air into the system, allowing the waste-water in the drainage tank 1003 to flow back into the drum. The drain pump is then operated again for a predetermined length of time, enough to allow the drain tank 1003 to refill and push the air through the drain tank outlet pipe 1004. Alternatively, a fluid level sensor may be provided in the drain tank 1003 to indicate when the drain tank is full. The drain pump is then stopped and the drain tank allowed to empty again, introducing more air into the system, until the level of waste-water in the conduit 1002 and the drum 1000 have equalised. This cycle of operating and stopping the drain pump 1001 is repeated until only air is present in the filter 1005, which can then be opened and serviced. The purpose of the timed drainage pulse and or fluid sensor is to ensure that waste-water does not overflow from the drain tank 1003 into the drain tank outlet pipe 1004 and begin filling the filter again.

The advantage of this embodiment is that it removes the need for a bypass system around the filter unit. A bypass has the disadvantage that if it has to be operated it releases contaminated waste-water into the environment.

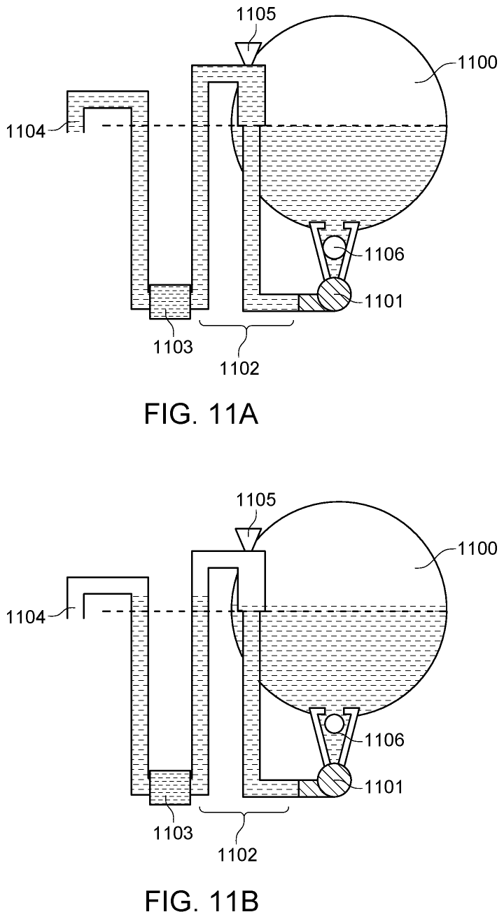

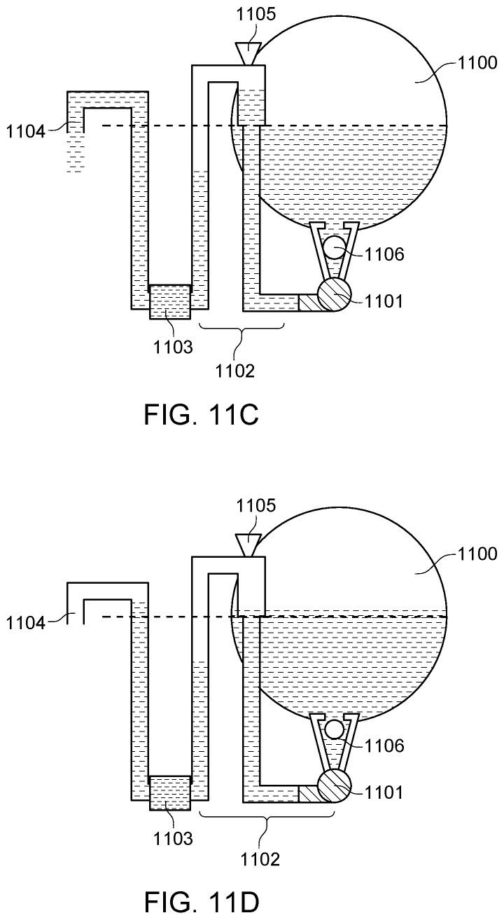

Washing machines that are fitted with a stopper require a modification to operate effectively in this embodiment, as shown in FIGS. 11A to 11D. During normal drainage, the stopper 1106 moves out of the sump opening to allow waste-water to flow through. The filter 1103 is saturated during this operation. When a blockage is detected, the drain pump 1101 is stopped and the stopper 1106 floats back to the top of the sump. It will prevent the waste-water flowing back from the drainage tank into the drum 1100 and therefore no air will be introduced through the air inlet 1105. Therefore, in an embodiment, the stopper is modified so that it doesn't fully seal to the top of the sump, allowing back flow but preventing detergent from escaping at the start of the wash. This is shown in FIG. 11B, where waste-water has emptied from the drain tank into the drum, past the stopper 1106, allowing air into the drain tank. The drain pump is then operated again to refill the drain tank, as shown in FIG. 11C and push air further towards the filter 1103. When the drain tank is full again, the drain pump 1101 is stopped and waste-water flows back into the drum past the stopper, allowing more air into the drain tank. The cycle is repeated until the filter is drained and can be opened and inspected. For confirmation, the drum 1100 and air-pump system 1102 are separate and are shown in the Figures overlapping, as the air-pump system 1102 is in front of the drum 1100.

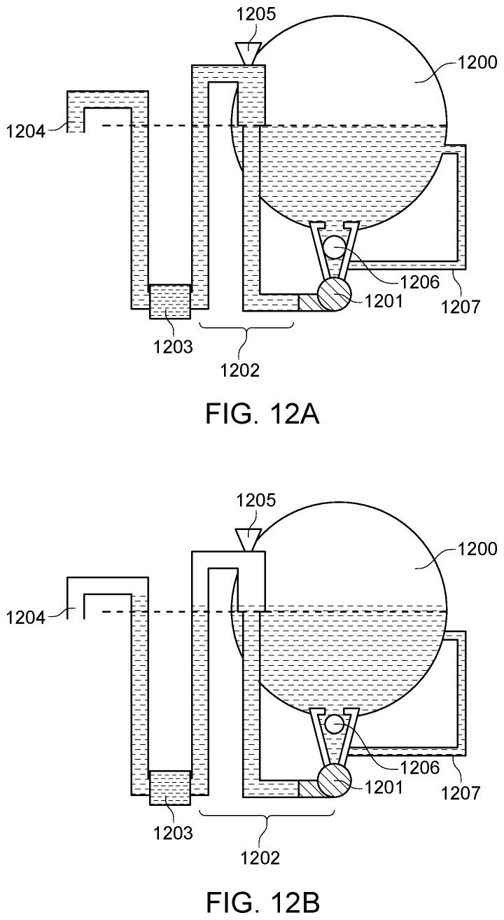

In a further embodiment, as shown in FIGS. 12A and 12B, a standard stopper 1206 is used, but a bypass conduit 1207 is provided between the sump and the drum 1200. During normal drainage, the stopper 1206 moves out of the sump opening to allow waste-water to flow through, as shown in FIG. 12A. The filter 1203 is saturated during this operation. When a blockage is detected, the drain pump 1201 is stopped and the stopper 1206 floats back to the top of the sump. Waste-water then flows through the bypass conduit 1207 back to the drum 1200. This is shown in FIG. 12B, where waste-water has emptied from the drain tank into the drum, through the bypass conduit 1207, allowing air into the drain tank. The drain pump is then operated again to refill the drain tank and push air further towards the filter 1203. When the drain tank is full again, the drain pump 1201 is stopped and waste-water flows back into the drum through the bypass conduit 1207, allowing more air into the drain tank. The cycle is repeated until the filter is drained and can be opened and inspected.

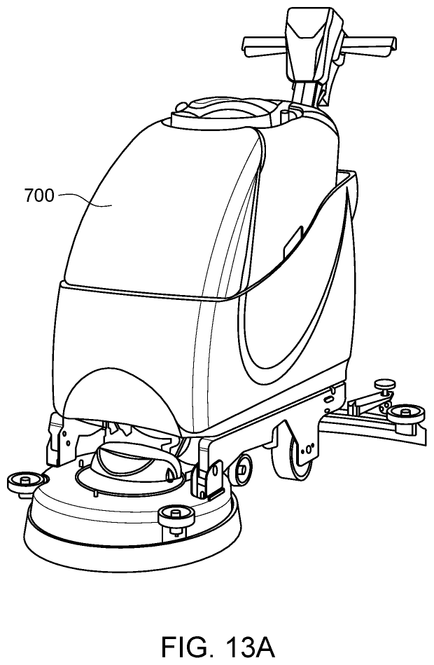

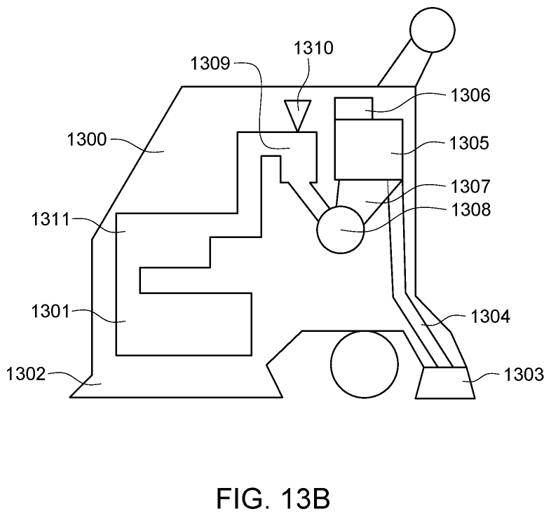

In a further embodiment, a floor cleaner is provided with an embodiment of the forced-air filter drainage system, as shown in FIGS. 13A and 13B. The floor cleaner 1300 is a mobile unit that includes a system of tanks and brushes to apply soapy water to a dirty floor. A clean water tank 1301 feeds clean water to a rotating brush 1302. As the unit is moved along the floor, dirty water is sucked up through inlet 1303, through ducting 1304 and deposited into a dirty water holding tank 1305, by means of a vacuum pump 1306. The holding tank has a sump 1307 that is drained by means of drain pump 1308. A drainage tank 1309 is provided downstream of the drain pump 1307 and a one-way air inlet valve 1310 is provided in the drainage tank 1309. Dirty water from the drainage tank is pumped through a filter unit 1310 and the resulting clean water is returned to the clean water tank 1301. To empty the filter, the vacuum pump is turned off so that no new effluent is entering the dirty water tank. The dirty water tank is emptied until only the sump is full. Then the drainage pump is operated in the same way as described for the washing machine filter above, i.e. the drainage pump is periodically turned on and off so that the waste-water is cycled between the sump and the drain tank to create a piston effect, whereby air is sucked into the system through the air valve. This water-piston drives air through the system until all of the waste-water is evacuated from the filter.

A larger-scale embodiment of the invention can be applied to the treatment of effluent in Wastewater Treatment Plants. For example, the chamber of the filter could be 1 meter in diameter or 2 meters or greater.

Another example application is in a manufacturing facility where the filtration of particles out of a fluid may be conducted, such as a textile manufacturing facility. In this example the filter system described above could be used during the capture microfibres and microplastic from factory processes.

In another embodiment the appliance, such as a washing machine, may not include a drainage pump in the housing of the appliance and instead be reliant on draining via gravity by opening a valve to evacuate the water from the appliance. In this circumstance an embodiment of the filter system described above, and as shown in FIGS. 5A to 5I, can be housed externally to the appliance and connected to the outlet of the gravity drainage valve. A separate unit containing a drain pump, a non-return assembly, an air inlet and a filter is provided externally to the appliance, and including a controller for the drain pump, which can be controlled to pump air through the system to drain the filter, as described above. Gravity drainage, as opposed to pump drainage, is common in both commercial washing machines and manufacturing facilities.

In another embodiment, part of the filter system may be housed internally to the appliance, with other components housed externally to the appliance. In this embodiment, the filter system shown in FIGS. 5A to 5I, is arranged such that the sump 208 and drain pump 205 are housed internally to the appliance, whilst other components, including the drain tank 207, air inlet 210 and filter 204, are housed externally as part of an external filter system. In this embodiment it may be preferrable to include a communication system between the filter system and the appliance to control the operation of the drain pump 205 within the appliance to facilitate the air-pumping operation to drain the filter 204.

1. A filter system for liquid effluent handling equipment, such equipment including a reservoir for holding effluent and a pump for emptying the reservoir, wherein the filter system includes:
a holding volume for holding a quantity of effluent, the holding volume being fluidly communicable with an outlet of the pump, and
a filter unit having an inlet in fluid communication with, and downstream from, the holding volume, the filter unit further having an outlet that is connectable to a sewerage system,
the filter system characterised in having
a non-return assembly between the holding volume and the filter unit for preventing effluent from returning to the holding volume, and
an air inlet in fluid communication with the holding volume, the air inlet arranged to allow air into the holding volume, and
a control unit for controlling the pump.

2. The filter system of claim 1, wherein the non-return assembly comprises arranging the filter unit below the top of the holding volume.

3. The filter system of claims 1 or 2, wherein at least a part of the holding volume is located above the pump.

4. The filter system of any preceding claim, wherein a sensor is provided to detect a condition of the reservoir and/or pump and/or the holding volume.

5. The filter system of any preceding claim, wherein the detected condition is whether the reservoir is empty or whether the pump has cavitated or when the holding volume has effluent in it.

6. The filter system of claim 5, wherein the control apparatus is arranged to deactivate the pump on detecting the condition.

7. A filter system for liquid effluent handling equipment, such equipment including a reservoir for holding effluent, wherein the filter system includes:
a pump for emptying the reservoir,
a holding volume for holding a quantity of effluent, the holding volume being fluidly communicable with an outlet of the pump, and
a filter unit having an inlet in fluid communication with, and downstream from, the holding volume, the filter unit further having an outlet that is connectable to a sewerage system,
the filter system characterised in having
a non-return assembly between the holding volume and the filter unit for preventing effluent from returning to the holding volume, and
an air inlet in fluid communication with the holding volume, the air inlet arranged to allow air into the holding volume, and
a control unit for controlling the pump.

8. A washing machine having the filter system of claims 1 to 7.

9. The washing machine of claim 8, wherein the washing machine has a drum and wherein the filter system is arranged to recirculate the effluent from the outlet of the filter unit back into the drum.

10. The washing machine of claim 8 or 9, wherein the air inlet of the filter system is located higher than the highest water level of water in the drum when in use.

11. The washing machine of claims 8 to 10, wherein the washing machine has a sump with a floating stopper and means to bypass the stopper.

12. A floor cleaner having the filter system of claims 1 to 7.

13. A waste-water treatment plant having the filter system of claims 1 to 7.

14. A textile manufacturing facility having the filter system of claims 1 to 7.

15. A method of operating the filter system of claims 1 to 7, comprising the steps of
operating a drain pump to drain effluent from a reservoir into a holding volume and then into a filter unit and from the filter unit to an outlet,
determining when the reservoir has drained to a pre-determined level,
then operating the drain pump so that a pre-determined volume of effluent returns to the reservoir,
allowing air into the holding volume as the effluent returns to the reservoir from the holding volume, while preventing effluent from returning from the filter unit to the holding volume.
